(19) United States
(12) Patent Application Publication
(10) Pub. No.: US 2007/0092272 A1
(43) Pub. Date: Apr. 26, 2007

(54) Method and device for determining an amount of material in a container

(76) Inventors: Scott K. Hymas, Boise, ID (US); Patrick S. Dougherty, Boise, ID (US); Anthony P. Holden, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/258,255

(22) Filed: Oct. 25, 2005

(51) Int. Cl. G03G 15/08

(52) U.S. Cl. 399/27

(57) ABSTRACT

An amount of material in a container is determined by measuring a time it takes for an object to move through the material, and determining the amount of material based on the measured time.

### BACKGROUND

Determining an amount of material in a replaceable or refillable container of a device, such as a toner cartridge in an imaging device, is usually desirable for knowing when to replace or refill the container. Problems with existing methods for measuring an amount of material remaining in such containers include sensor resolution and decreasing signal linearity with decreasing amounts of material.

### DESCRIPTION OF THE DRAWINGS

FIG. 1 is a block diagram of an embodiment of an imaging device, according to an embodiment of the invention.

FIG. 2 is an isometric view of an embodiment of a cartridge, according to another embodiment of the invention.

FIG. 3 is an isometric view of an embodiment of a torque sensor, according to another embodiment of the invention.

FIG. 4 is an end view of an embodiment of a torque sensor, according to another embodiment of the invention.

FIG. 5 is a schematic diagram of an embodiment of an electrical circuit that includes portions of a torque sensor, according to another embodiment of the invention.

FIGS. 6A-6D illustrate an embodiment of a torque sensor in operation, according to another embodiment of the invention.

FIG. 7 is a plot of an exemplary signal output of a torque sensor, according to another embodiment of the invention.

FIG. 8 is an exemplary plot of a time it takes an object to move through a material versus the amount of material, according to another embodiment of the invention.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

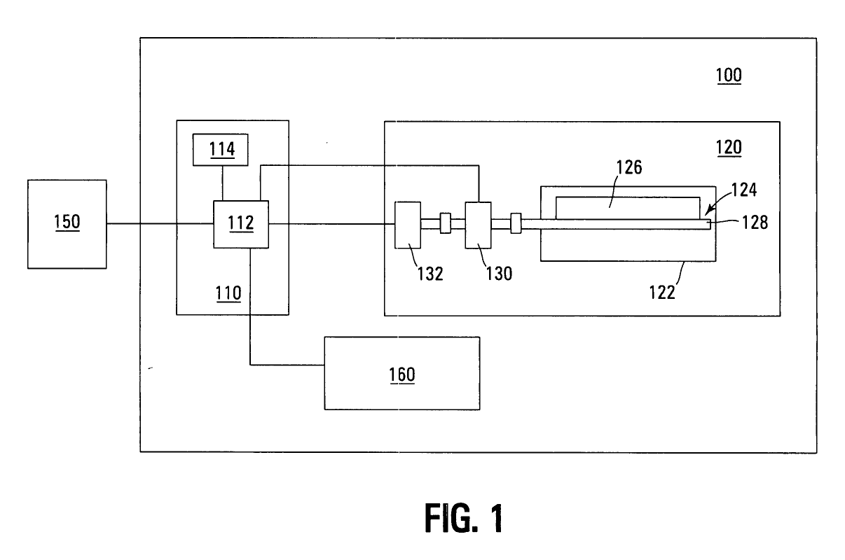

FIG. 1 is a block diagram of an imaging device 100, such as an electrographic imaging device, according to an embodiment. Imaging device 100 can be a printer, a copier, digital network copier, a multi-function peripheral (MFP), a facsimile machine, etc. Imaging device 100 has a controller 110, such as a formatter, for interpreting image data and rendering the image data into a printable image. The printable image is provided to a print engine 120 to produce a hardcopy image on a media sheet. For one embodiment, print engine 120 includes a light source, such as a laser or light-emitting diodes or both and is configured to receive a refillable or replaceable container, such as a toner cartridge 122. For another embodiment, the imaging device 100 is capable of generating its own image data, e.g., a copier, via scanning an original hardcopy image.

For one embodiment, a stirrer 124 is disposed in cartridge 122 and includes a paddle attached to a rotatable shaft 128. For one embodiment, when cartridge 122 is inserted into print engine 120, rotatable shaft 128 is coupled to a torque sensor 130 that may be coupled directly or indirectly to a motor 132.

For another embodiment, controller 110 includes local logic 112. Alternatively, local logic 112 may be separate from controller 110, and, for another embodiment, may be included in print engine 120. Local logic 112 is configured to control motor 132 and to receive signals indicative of torque applied to stirrer 124 from torque sensor 130. For one embodiment, local logic 112 determines an amount of marking material remaining in cartridge 122 based on the sensed torque and information from a memory 114 that may part of controller 110. For some embodiments, local logic 112 may be configured to send information, such as the amount of marking material remaining in cartridge 122, to remote logic 150, e.g., an external computer or other device. For other embodiments, local logic 112 may be configured to cause an indication of the amount of marking material remaining in cartridge 122 to be displayed on a display 160 of imaging device 100.

For one embodiment, memory 114 is computer-usable storage media that can be fixedly or removably attached to controller 110. Some examples of computer-usable media include static or dynamic random access memory (SRAM or DRAM), read-only memory (ROM), electrically-erasable programmable ROM (EEPROM or flash memory), magnetic media and optical media, whether permanent or removable. For one embodiment, memory 114 contains computer-readable instructions to cause local logic 112 to determine the amount of marking material in cartridge 122 as well as imaging device 100 to perform other functions.

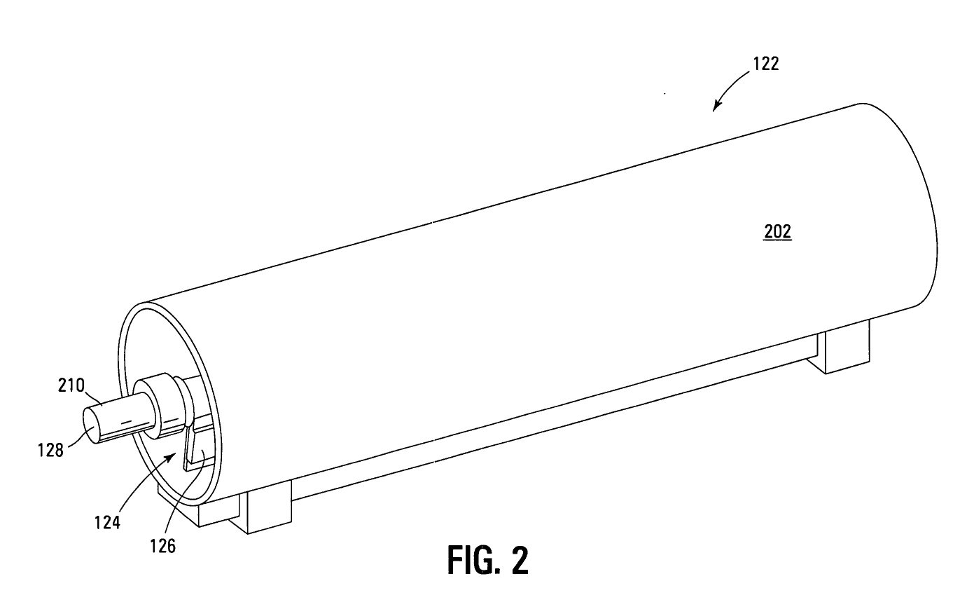

FIG. 2 is an isometric view of cartridge 122, according to another embodiment. Marking material is contained in a shell 202. Stirrer 124 is disposed in shell 202 for stirring the marking material.

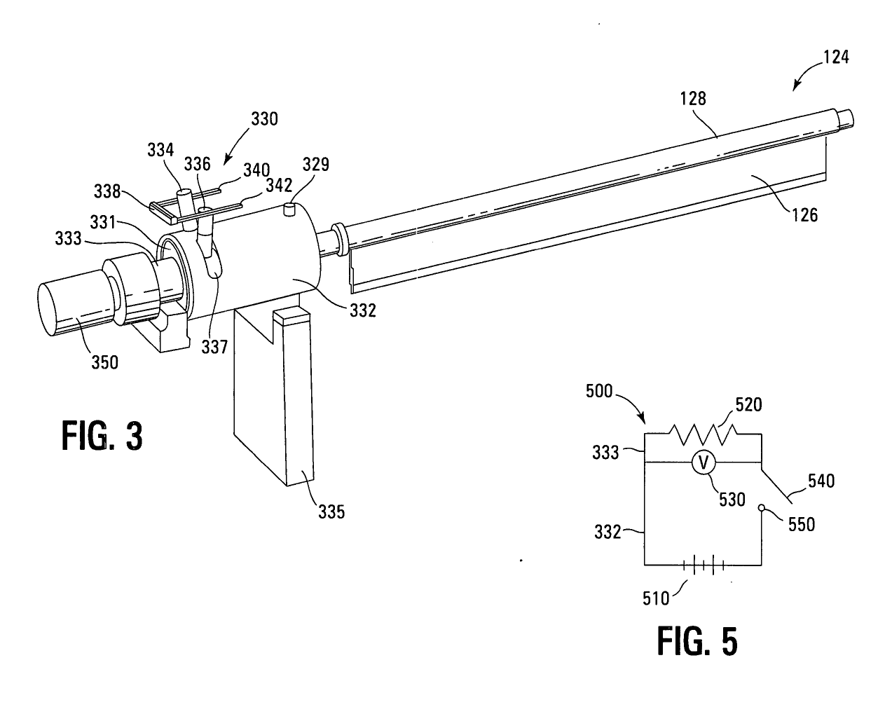

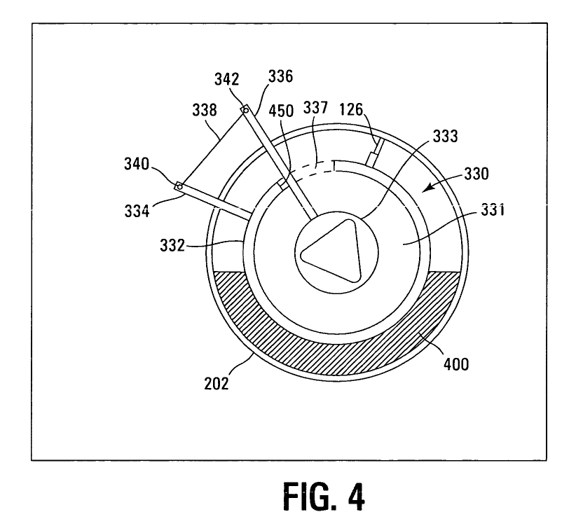

Reference will now be made to FIGS. 3 and 4. FIG. 3 is an isometric view of a torque sensor 330 coupled to stirrer 124 removed from shell 202 of FIG. 2, according to another embodiment. FIG. 4 is an end view of torque sensor 330 connected to stirrer 124 while disposed in shell 202. Torque sensor 330 includes a sleeve 332 that is connected to shaft 128 of stirrer 124, e.g., by a pin 329 that may be non-conductive and that passes diametrically through sleeve 332 and a hole 210 (FIG. 2) passing through shaft 128. Sleeve 332 is free to rotate relative to a support 335 so that sleeve 332 and stirrer 124 rotate together. A drive shaft 333 that is coupleable to a motor, such as motor 132 of FIG. 1, e.g., by a coupler 350, extends into sleeve 332 and can rotate within sleeve 332 relative to sleeve 332. For one embodiment, a bushing 331, e.g., that may be non-conductive, is disposed between sleeve 332 and drive shaft 333 and is fixed to sleeve 332. Note that drive shaft 333 is free to rotate within busing 331.

A pin 334 is attached to sleeve 332. A pin 336 passes through a slot 337 formed in sleeve 332 and is attached to drive shaft 333. Non-conducting pins 340 and 342 are respectively attached to pins 334 and 336, e.g., such as by a force fit in holes passing through pins 334 and 336. A spring 338 interconnects non-conducting pins 340 and 342, and thus spring 338 interconnects sleeve 332, and thus stirrer 124, to drive shaft 333. Therefore, in operation, the motor rotates drive shaft 333, and the rotation is imparted to sleeve 332 and thus stirrer 124, by spring 338. For one embodiment, a plurality of springs in parallel may interconnect non-conducting pins 340 and 342.

FIG. 5 is a schematic diagram of an electrical circuit 500 that includes a portion drive shaft 333 and sleeve 332. For one embodiment, a power supply 510, such as a DC power supply, is connected in series with sleeve 332. For another embodiment, a load resistor 520 is connected in series with drive shaft 333. For one embodiment, a sensor 530, e.g., configured as a voltage sensor, as shown in FIG. 5 is electrically connected in parallel with load resistor 520. For another embodiment, sensor 530 is connected to logic, such as logic 112 of FIG. 1. For one embodiment, sensor 530 may be configured as a current sensor in which case sensor 530 would be connected in series with load resistor 520

A switch 540 (FIG. 5) depicts the movement of pin 336 within slot 337 (FIGS. 3 and 4) and a contact point 550 corresponds to an end 450 (FIG. 4) of slot 337. Therefore, when pin 336 is not in contact with end 450, switch 540 is open, and sensor 530 senses a low voltage. When pin 336 is in contact with end 450, switch 540 is closed and a voltage sensed by sensor 530 is relatively high compared to that when switch 540 is open and is essentially the voltage drop across load resistor 520. For another embodiment, when switch 540 is closed a current sensed by sensor 530 is relatively high compared to that when switch 540 is open, i.e., the current is zero when switch 540 is open.

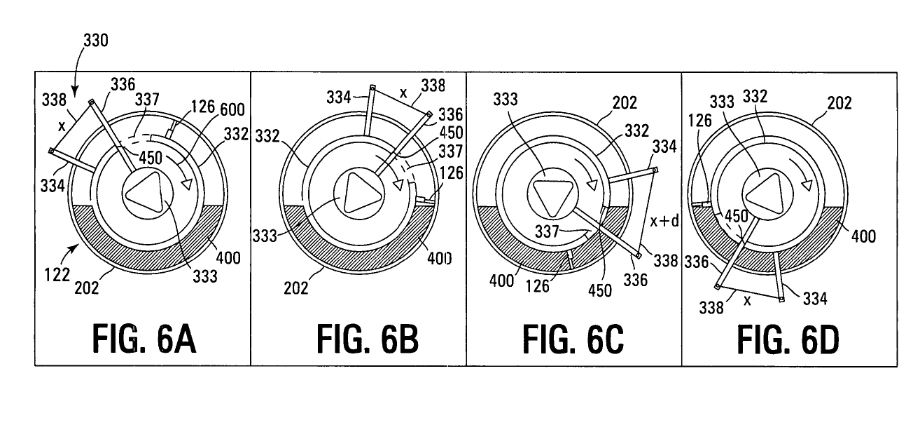

FIGS. 6A-6D illustrate cartridge 122 and torque sensor 330 in operation, according to another embodiment. FIG. 6A corresponds to a state where paddle 126 has not yet engaged marking material 400 and is moving in the direction of arrow 600. Note that pin 336 (attached to drive shaft 333) is in contact with end 450 of slot 337. This corresponds to switch 540 being in contact with contact point 550 of circuit 500 (FIG. 5). Therefore, circuit 500 is closed. Note that spring 338 has a length of X At spring length X, the force exerted by spring 338 between pin 334 (attached to sleeve 332) and pin 336 is sufficient to bias pin 336 against end 450 of slot 337. That is, the spring force is the dominant force acting between pins 334 and 336 because paddle 126 is moving through a marking-material-free region, not marking material 400. FIG. 6B corresponds to a state where paddle 126 is about to engage marking material 400. Note that the length of spring 338 remains at X, and spring 338 continues to bias pin 336 against end 450 of slot 337 so that circuit 500 remains closed.

FIG. 6C corresponds to a state where paddle 126 has engaged marking material 400 and is moving through marking material 400. As paddle 126 moves through marking material 400, marking material 400 exerts a resistive force on paddle 126 in a direction opposite the motion of paddle 126. The resistive force is imparted to sleeve 332, causing drive shaft 333 to exert more force on sleeve 332 in order to move paddle 126 through the marking material 400. This force acts to stretch spring 338 to the length X+d, and pin 336 is displaced from end 450 of slot 337 and is located between opposing ends of slot 337, as shown in FIG. 6C. Therefore, circuit 500 (FIG. 5) is open.

FIG. 6D corresponds to a state where paddle 126 has just disengaged marking material 400. This relieves the resistance on paddle 126, thus reducing the force between drive shaft 333 and sleeve 332 via spring 338. Therefore, spring 338 is able to bias pin 336 against end 450 of slot 337, and circuit 500 (FIG. 5) is closed.

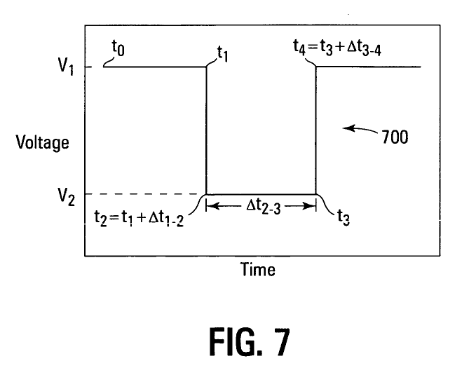

FIG. 7 is a plot of an exemplary voltage, e.g., sensed by sensor 530 (FIG. 5), during rotation of paddle 126. At a time to in FIG. 7, paddle 126 is located as shown in FIG. 6D. As described above, spring 338 biases pin 336 against end 450 of slot 337, and circuit 500 (FIG. 5) is closed. Therefore, sensor 530 senses a high voltage V₁. As paddle 126 moves through the marking material-free region between the position depicted in FIG. 6D, through the position depicted in FIG. 6A, and to the position depicted in FIG. 6B corresponding to time t₁ in FIG. 7, spring 338 biases pin 336 against end 450 of slot 337 so that circuit 500 remains closed. Therefore, the voltage sensed by sensor 530 remains at V₁, as shown in FIG. 7.

At a small time increment Δt₁₋₂ after time t₁, i.e., at a time t₂=t₁+Δt₁₋₂, paddle 126 engages marking material 400, and the resistance due to marking material 400 causes drive shaft 333 to exert more force on sleeve 332 in order to move paddle 126 through the marking material 400 via spring 338. This force acts to stretch spring 338 so that pin 336 is displaced from end 450 of slot 337, causing circuit 500 (FIG. 5) to open. Opening of circuit 500 produces an abrupt decrease in the voltage sensed by sensor 530, as is shown in FIG. 7 by the abrupt decrease from high voltage V₁ at time t₁ to a low voltage V₂ at time t₂. As paddle 126 moves through marking material 400, as shown in FIG. 6C, the voltage sensed by sensor 530 remains at V₂ until a time t₃, as shown in FIG. 7, just before paddle 126 disengages marking material 400.

At a small time increment Δt₃₋₄ after time t₃, i.e., at a time t₄=t₃+Δt₃₋₄, paddle 126 completes one rotation and returns to the position shown in FIG. 6D. That is, paddle 126 has just disengaged marking material 400 allowing spring 338 to bias pin 336 against end 450 of slot 337, thereby closing circuit 500 (FIG. 5). Therefore, the voltage sensed by sensor 530 abruptly increases from V₂ at time t₃ back to V₁ at time t₄, as shown in FIG. 7. The voltage-versus-time behavior depicted in FIG. 7 between time t₀ and t₄ is repeated for each rotation of paddle 126 for a fixed amount of marking material 400.

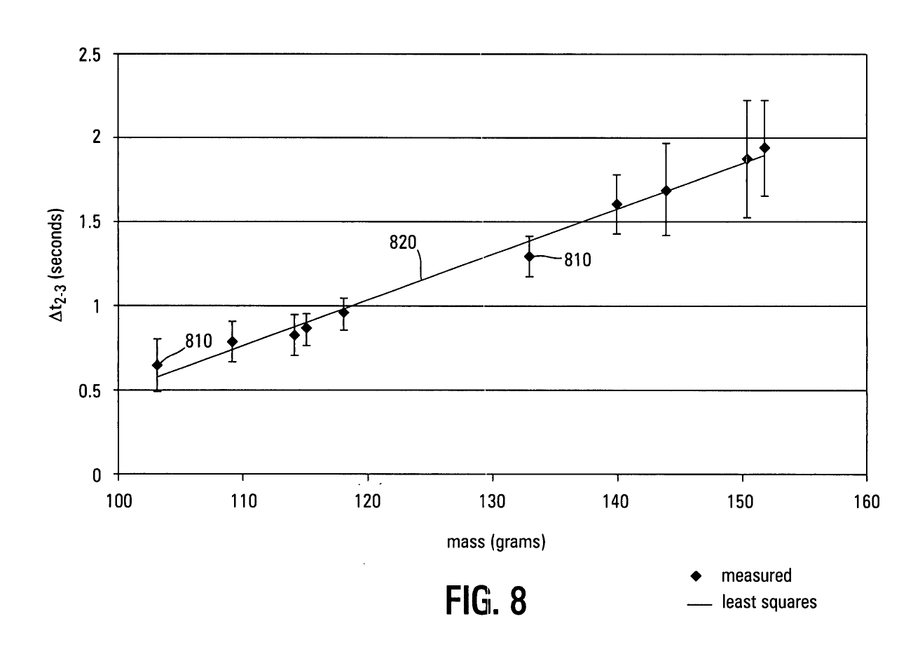

For one embodiment, the time it takes paddle 126 to move through marking material 400, e.g., the time the voltage sensed by sensor 530 is low, represented by the width Δt₂₋₃=t₃−t₂ of inverse voltage pulse 700 in FIG. 7, decreases at substantially a constant rate with decreasing amounts of marking material 400. That is, the time it takes paddle 126 to move through marking material 400 is substantially a linear function of the amount of marking material 400 contained in cartridge 122. This is exemplified for one embodiment in FIG. 8.

The results of FIG. 8 were obtained from a simulation using salt to simulate marking material 400 in the configurations of FIGS. 2-4. Each of data symbols 810 corresponds to a measurement of a mass of salt contained in shell 202 and the width of the voltage pulse 700 averaged over a number of rotations of paddle 126 for that mass of salt. The line 820 was obtained from a least squares fit of the data represented by data symbols 810. A similar procedure may be used to obtain calibrations for marking material 400 that may be input into memory 114 of FIG. 1 as equations or tables. Then, for one embodiment, logic 112 (FIG. 1) receives a voltage pulse from torque sensor 330 (FIG. 1), determines the width of the voltage pulse, and inputs the width into the calibration equation or table to obtain the mass of marking material 400 in cartridge 122. For one embodiment, the width may be obtained from an average of a plurality of voltage pulses.

Note that the time it takes paddle 126 to pass through marking material 400 can also be determined from current pulses for some embodiments. Note further that the current would be zero (or low) when circuit 500 is open, i.e., when paddle is passing through marking material 400, and high when circuit 500 is closed, i.e., when paddle is not passing through marking material 400.

For other embodiments, the torque sensor is as shown for torque sensor 130 in FIG. 1. That is, the torque sensor measures the torque input to shaft 128 and outputs a signal, such as a current or voltage, that is proportional to the torque input. When paddle 126 is moving through the marking-material free region the torque input will be low and the torque sensor will output a corresponding signal value. When paddle 126 is moving through the marking material, the torque input will be high and the torque sensor will output a corresponding signal value. Therefore, a signal pulse, such as voltage pulse 700 of FIG. 7, will be generated as paddle 126 respectively passes through the marking material and the marking-material free region. That is, sensing changes in torque due to changes in the resistance (or force) on paddle 126 as it engages and disengages marking material 400 enables the time it takes for paddle 126 to move through marking material 400 to be determined and thus the amount of marking material 400 to be determined.

### CONCLUSION

Although specific embodiments have been illustrated and described herein it is manifestly intended that the scope of the claimed subject matter be limited only by the following claims and equivalents thereof.

1. A method of determining an amount of material in a container, comprising:
measuring a time it takes for an object to move through the material; and
determining the amount of material based on the measured time;
wherein the object is a paddle.

2. The method of claim 1, wherein measuring a time it takes for an object to move through the material comprises sensing a resistive force exerted by the material on the object.

3. The method of claim 1, wherein measuring a time it takes for an object to move through the material comprises determining a width of a signal pulse.

4. The method of claim 3, wherein the signal pulse is produced by the object successively engaging and disengaging the material.

5. (canceled)

6. A method of determining an amount of marking material in a cartridge disposed in an imaging device, comprising:
measuring a time it takes for a stirrer, disposed in the cartridge, to move through the marking material; and determining the amount of marking material based on the measured time;
wherein the stirrer is a paddle.

7. (canceled)

8. The method of claim 6, wherein measuring a time it takes for a stirrer to move through the marking material comprises generating a signal pulse in response to a change in torque exerted on the stirrer due to the stirrer successively engaging and disengaging the material.

9. The method of claim 8, wherein measuring a time it takes for a stirrer to move through the marking material further comprises determining a width of the signal pulse.

10. A computer-usable medium containing computer-readable instructions for causing a device to perform acts, comprising:
measuring a time it takes for an object to move through a material; and
determining the amount of material based on the measured time, wherein the amount of material increases substantially linearly with the time it takes for the object to move through the material.

11. The computer-usable medium of claim 10, wherein, in the method, measuring a time it takes for an object to move through the material comprises sensing a resistive force exerted by the material on the object.

12. The computer-usable medium of claim 10, wherein, in the method, measuring a time it takes for an object to move through the material comprises determining a width of a signal pulse.

13. The computer-usable medium of claim 12, wherein, in the method, the signal pulse is produced by the object successively engaging and disengaging the material.

14. (canceled)

15. A device for determining an amount of material in a container, comprising:
a means for measuring a time it takes for an object to move through the material; and
a means for determining the amount of material based on the measured time;
wherein the object is a paddle.

16. The device of claim 15, wherein the time measuring means comprises a means for sensing the object successively engaging and disengaging the material.

17. The device of claim 16, wherein the sensing means comprises a means for sensing changes in force exerted on the object due to the object successively engaging and disengaging the material.

18. A device for determining an amount of material in a container, comprising:
a torque sensor coupleable to an object disposed in the container; and
logic electrically connected to the torque sensor;
wherein the logic is configured:
to determine a time it takes for the object to move through the material based on a signal received from the torque sensor indicative of the torque; and
to determine the amount of material from the determined time;
wherein the object is a paddle.

19. The device of claim 18 further comprises a computer-usable medium coupled to the logic, wherein the computer-usable medium contains a calibration that is used by the logic to determine the amount of material from the measured time.

20. The device of claim 19, wherein the calibration is a linear function of the amount of material versus the time it takes for the object to move through the material.

21. The device of claim 18, wherein the logic determines the time it takes for the object to move through the material from a width of at least one pulse in the signal received from the torque sensor.

22. The device of claim 21, wherein the pulse is produced by changes in torque due to the object successively engaging and disengaging the material.

23. A device for determining an amount of material in a container, comprising:
a torque sensor coupleable to an object disposed in the container; and
logic electrically connected to the torque sensor;
wherein the logic is configured:
to determine a time it takes for the object to move through the material based on a signal received from the torque sensor indicative of the torque; and
to determine the amount of material from the determined time;
wherein the torque sensor comprises:
a sleeve coupleable to the object for rotation therewith
a drive shaft rotatably attached to the sleeve and coupleable to a motor;
a biasing device mechanically connecting the sleeve to the drive shaft for biasing the drive shaft into electrical contact with the sleeve when the object is disengaged from the material to form a closed electrical circuit that includes the drive shaft and the sleeve;
wherein the drive shaft moves out of electrical contact with the sleeve against a biasing force of the biasing device when the object engages the material to open the electrical circuit.

24. The device of claim 23, wherein the electrical circuit includes a power supply connected in series with the sleeve.

25. The device of claim 24, wherein the electrical circuit includes a signal sensor coupled to the logic.

26. An imaging device comprising:
a controller; and
a torque sensor electrically connected to the controller and mechanically couplable to a stirrer of a marking-material cartridge;
wherein the controller is configured:
to determine a time it takes for the stirrer to move through the marking material based on a signal received from the torque sensor indicative of the torque; and
to determine the amount of marking material from the determined time
wherein the stirrer is a paddle.

27. The imaging device of claim 26, wherein the controller determines the time it takes for the stirrer to move through the marking material from a width of at least one pulse in the signal received from the torque sensor.

28. The device of claim 27, wherein the pulse is produced by changes in torque due to the stirrer successively engaging and disengaging the marking material.

29. (canceled)

30. The device of claim 23 further comprises a computer-usable medium coupled to the logic, wherein the computer-usable medium contains a calibration that is used by the logic to determine the amount of material from the measured time.

31. The method of claim 1, wherein determining the amount of material based on the measured time comprises inputting the measured time into a calibration that is a linear function of the amount of material versus the time it takes for the object to move through the material.

32. The method of claim 1, wherein the measured time is substantially linearly related to the amount of material.

33. The method of claim 6, wherein the measured time is substantially linearly related to the amount of marking material.

34. The imaging device of claim 26, wherein the controller determines the amount of marking material using a linear relationship between the determined time and the amount of marking material.
